(19) United States
(12) Patent Application Publication
(10) Pub. No.: US 2025/0212096 A1
(43) Pub. Date: Jun. 26, 2025

(54) Augmented Multi-Link Neighbor Lists

(71) Applicant: Cisco Technology, Inc., San Jose, CA (US)

(72) Inventors: Malcolm Smith, Richardson, TX (US); Indermeet Gandhi, San Jose, CA (US); Jerome Henry, Pittsboro, NC (US)

(21) Appl. No.: 18/616,025

(22) Filed: Mar. 25, 2024

Related U.S. Application Data
(60) Provisional application No. 63/614,903, filed on Dec. 26, 2023.

(51) Int. Cl. H04W 48/16

(52) U.S. Cl. CPC H04W 48/16

(57) ABSTRACT

Various embodiments described herein are configured to provide an augmented neighbor list during wireless network roaming. The augmented neighbor list can be formatted such that the neighbor recommendations provided to a mobile computing device during roaming include not just a single neighbor recommendation, but also a neighbor recommendation for each link associated with the mobile computing device. In this way, multi-link operations can become more efficient such that neighbor lists are augmented to add the per-link recommendations. Furthermore, one or more machine learning processes can be utilized to select the best per-link neighbor recommendation based on a series of inputs configured by the network administrator. The augmented neighbor list may also be formatted such that legacy devices may still be compatible by formatting the augmented neighbor list such that only one recommendation occurs. Sometimes, the recommendations are configured per mobile computing device link instead of the available network device links.

### CROSS-REFERENCE TO RELATED APPLICATION

This application claims the benefit of U.S. Provisional Patent Application No. 63/614,903, filed Dec. 26, 2023, which is incorporated by reference herein in its entirety.

The present disclosure relates to wireless networking. More particularly, the present disclosure relates to generating and utilizing augmented neighbor lists in multi-link network environments.

### BACKGROUND

Wi-Fi, or wireless fidelity, is of paramount importance in the modern era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

For example, a device can traditionally scan for target basic service set identifications (BSSIDs) based in part on its own scans and in part on the access point (AP) recommended neighbor list (NL). However, with forthcoming versions of wireless networking, multiple links (per AP) are now candidates. While this choice is convenient, it also presents a number of challenges and opportunities for optimization.

### SUMMARY OF THE DISCLOSURE

Systems and methods generating and utilizing augmented neighbor lists in multi-link network environments in accordance with embodiments of the disclosure are described herein. In some embodiments, a device includes a processor, at least one wireless transceiver configured to provide access to a network, and a memory communicatively coupled to the processor, wherein the memory includes a neighbor list logic that is configured to receive a request for a neighbor list from a network device, determine a presence of two or more links associated with the network device, and generate an augmented neighbor list based on the two or more links.

In some embodiments, the augmented neighbor list includes a plurality of recommended links.

In some embodiments, the plurality of recommended links are configured on a per-link basis.

In some embodiments, the neighbor list logic is further configured to gather an available basic service set identifier (BSSID) prior to generating the augmented neighbor list.

In some embodiments, the neighbor list logic is further configured to determine a recommended BSSID prior to generating the augmented neighbor list.

In some embodiments, the augmented neighbor list is configured with at least the recommended BSSID.

In some embodiments, the neighbor list logic is further configured to evaluate each link associated with the recommend BSSID.

In some embodiments, each evaluated link is assigned a link identification.

In some embodiments, each link is compiled into one or more categories.

In some embodiments, the augmented neighbor list is formatted for compatibility with legacy network devices.

In some embodiments, the compatibility is achieved through grouping of at least one basic service set identifier (BSSID).

In some embodiments, the grouping of the at least one BSSID configures the augmented neighbor list to point to a single entry.

In some embodiments, the request for a neighbor list includes at least a bonding preference for receiving recommendations for pairing with multi-link devices.

In some embodiments, generating the augmented neighbor list is based on at least the bonding preference.

In some embodiments, generating the augmented neighbor list includes at least evaluating at least one performance metric associated with the network device.

In some embodiments, the evaluation includes utilizing at least one machine-learning process configured to utilize the at least one performance metric as an input.

In some embodiments, the at least one performance metric can include received signal strength indicators, time to last mile performance, or quality of service adherence.

In some embodiments, a neighbor list logic is configured to receive a request for a neighbor list from a network device, determine a presence of two or more links associated with the network device, and evaluate a plurality of available links within neighboring access points, generate a link recommendation for each of the two or more links based on the plurality of available links, generate an augmented neighbor list based on the generated link recommendations.

In some embodiments, the neighbor list logic is further configured to transmit the augmented neighbor list to the network device.

In some embodiments, managing multi-link wireless network connections includes receiving a request for a neighbor list from a network device, parsing the received request, determining a presence of two or more links associated with the network device, and generating an augmented neighbor list on a per-link basis for each of the two or more links.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a schematic block diagram of a call flow in a power management system, in accordance with various embodiments of the disclosure;

FIG. 3 is a conceptual network diagram of various environments that a neighbor list logic may operate on a plurality of network devices, in accordance with various embodiments of the disclosure;

FIG. 4 is a flowchart depicting a process for utilizing an augmented neighbor list in accordance with various embodiments of the disclosure;

FIG. 5 is a flowchart depicting a process for generating an augmented neighbor list in accordance with various embodiments of the disclosure;

FIG. 6 is a flowchart depicting a process for requesting an augmented neighbor list in accordance with various embodiments of the disclosure;

FIG. 7 is a flowchart depicting a process for managing a request for an augmented neighbor list in accordance with various embodiments of the disclosure; and

FIG. 8 is a conceptual block diagram of a device suitable for configuration with a neighbor list logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to various problems described above, embodiments herein can be configured to generate augmented neighbor lists. In various embodiments, these augmented neighbor lists can be generated through one or more machine learning processes. As described in more detail below, the augmented neighbor lists can be configured for use in new as well as legacy devices. These augmented neighbor lists can be configured to include link recommendations for roaming wireless network devices based on multiple links, as well as the current links available to the wireless network devices. These link recommendations can be determined based on a number of factors, such as the current status of the neighboring links, the data transmission mode(s) utilized, and/or one or more performance metrics.

Multi-link devices (MLD) in wireless networking are devices capable of establishing and managing multiple simultaneous connections or “links” to other devices or networks. These devices play a role in enhancing network performance, increasing throughput, and improving reliability in various wireless communication scenarios. For example, in traditional wireless networking, devices typically establish a single connection with a single access point or peer device. However, in scenarios where high bandwidth requirements or redundancy are necessary, a single connection may not be sufficient to meet the demands. This is where multi-link devices come into play. MLDs can establish and maintain multiple connections concurrently, either to multiple access points, multiple peers, or a combination of both. For example, in a scenario where a device requires high-speed internet access, it can establish multiple connections to nearby access points simultaneously, aggregating the available bandwidth from each connection to achieve higher throughput. This technique is commonly known as link aggregation or bonding.

Moreover, MLDs can also utilize multiple connections for redundancy and failover purposes. By maintaining multiple connections to different access points or networks, MLDs can ensure continuous connectivity even if one connection fails or becomes unstable. This redundancy is particularly important in critical applications where uninterrupted connectivity is desired, such as industrial automation, healthcare, or public safety. Furthermore, MLDs may be deployed in mesh networking environments, where devices form ad-hoc networks and relay data through multiple hops to reach the destination. In mesh networks, MLDs act as multi-hop relays, forwarding data between nodes and optimizing the routing path to improve network efficiency and reliability.

In multi-link wireless networking, a “neighbor list” or “neighbor report” can refer to a list of neighboring devices or access points that are within range and can potentially establish a wireless connection with the device or node in question. This list is usually dynamically generated and updated based on the signals received by the device's wireless interface. The neighbor list contains information such as the MAC addresses or unique identifiers of nearby devices, their signal strengths, supported data rates, and other relevant parameters. This information is for the device to make decisions regarding which neighbors to communicate with and which links to establish for data transmission. In multi-link networking scenarios, having an accurate and up-to-date neighbor list is desired for efficient load balancing, network optimization, and seamless handover between different access points or wireless channels. By constantly monitoring and updating the neighbor list, devices can dynamically adapt to changes in the wireless environment, such as the presence of new neighbors or fluctuations in signal quality, to maintain optimal connectivity and performance.

Additionally, in wireless networking, particularly in cellular networks like LTE (Long-Term Evolution) or 5G, the concept of “Radio Neighbor Relation” (RNR) refers to the relationship between a base station (eNodeB in LTE or gNodeB in 5G) and its neighboring base stations or cells. When a mobile device communicates with a cellular network, it connects to a specific base station. However, as the mobile device moves, its signal strength with the current base station might weaken, while the signal strength with neighboring base stations might strengthen. To ensure continuous connectivity and optimize network performance, the network needs to manage handovers—transferring the connection from one base station to another—as the mobile device moves between cells.

The Radio Neighbor Relation can provide the network with information about neighboring cells, such as their identities, signal strengths, and other parameters. This information allows the network to make informed decisions about when and how to perform handovers. For example, if a mobile device's signal strength with its current base station drops below a certain threshold, the network might initiate a handover to a neighboring base station with a stronger signal. Additionally, the Radio Neighbor Relation can be for tasks such as interference management and resource allocation. By understanding the relationships between cells and the signal environment, the network can minimize interference between neighboring cells and optimize the allocation of resources, such as radio frequencies and bandwidth.

“RSSI” stands for Received Signal Strength Indicator, which is a measurement of the power level of the received radio signal in a wireless communication system, typically measured in decibels (dBm) or signal strength bars. RSSI is used to determine the strength of the signal being received by a wireless device, such as a smartphone, router, or access point. RSSI is an important metric in wireless networking as it can provide insight into the quality of the wireless connection. A higher RSSI value indicates a stronger signal and better signal quality, while a lower RSSI value indicates a weaker signal and potentially poorer connectivity. Wireless devices often use RSSI to make decisions regarding network connectivity, such as determining which access point to connect to in a Wi-Fi network or when to switch between different wireless channels or frequencies. However, it's important to note that RSSI alone may not provide a complete picture of the wireless environment, as factors like interference, noise, and multipath effects can also affect the performance of the network.

“BSSID” stands for Basic Service Set Identifier, which, in wireless networking, particularly in Wi-Fi networks based on the IEEE 802.11 standard, is a unique identifier assigned to each basic service set (BSS). A BSS is a group of stations (devices) that communicate with each other wirelessly. The BSSID is typically the MAC (Media Access Control) address of the access point (AP) or wireless router that creates the wireless network. It serves as a way to distinguish between different BSSs within the same area. Each BSS may have its own BSSID, and multiple BSSs can exist within the coverage area of a single access point, especially in environments with multiple access points or wireless routers. BSSIDs are used by wireless devices to identify and connect to specific wireless networks. When a device scans for available Wi-Fi networks, it detects and lists the BSSIDs of nearby access points, allowing users to select and connect to the desired network.

In wireless networking, “QoE” often refers to “Quality of Experience,” which is a subjective measure of a user's overall satisfaction with the performance and usability of a wireless network or service. Unlike “Quality of Service” (QoS), which focuses on technical parameters such as latency, packet loss, and throughput, QoE takes into account the user's perception of the network's performance. Several factors contribute to QoE, including network performance metrics like signal strength, throughput, latency, and jitter. Additionally, application performance plays a role, with different applications having varying requirements and sensitivities to network conditions. Factors such as ease of use, responsiveness of applications and interfaces, and overall satisfaction with the service contribute to the user experience. Moreover, the quality of content, especially for multimedia applications like video streaming or VoIP, greatly influences user perception. Reliability is also crucial, as users expect the network to be available and stable without frequent disruptions or downtime. Overall, monitoring and optimizing QoE are for network operators and service providers to ensure a positive user experience and maintain customer satisfaction.

In many embodiments, the candidate neighbor list/RNR can include co-located radios that may have near identical characteristics, as they are on the same AP (e.g. 4+4 transceivers, etc.), but they still may need to be scanned individually, thus wasting time (and airtime). In some embodiments, a link from the device may have good RSSI but offers poor QoE for the applications served. However, the other link (same MLD device) may be better (e.g., as observed by the AP). In additional embodiments, the device can have 2-3 links with different capabilities, but we only recommend a link for ONE of these (and which one is ambiguous). Individually, each item above is not fatal, but taken together represents a large opportunity for scan and roaming optimization, which by itself can improves QoE.

In various embodiments, the neighbor list returned by the AP can specify the device link (by link ID or any new identifier that corresponds to the link in the future) for which each BSSID is recommended. In some embodiments, a Link ID connected to a 5 GHz radio receives recommendations for other BSSIDs in the 5 GHz band, while the Link ID connected to a 6 GHz radio receives recommendations for other 6 GHz BSSIDs. These links could be on the same or different physical APs.

In further embodiments, the neighbor list can be modified to indicate grouped BSSIDs, thus pointing to one entry (legacy compatible), depending on which one or more of the other links are indicated (by WiFi7 MLD convention) as connected to the same physical AP MLD (novel). In still more embodiments, in the augmented 802.11k neighbor request, the device can add a capability/preference to either bond or not to bond MLD-related recommendations together. When the request is to bond, the singular recommendation (per AP) could be for the most representative link based on device performance (e.g., RSSI) or the link the AP (or a WLC, a management platform, or an admin) prefers based on QoS/T2LM preference (novel). These embodiments can solve some of the issues described above while certain problems are solved for devices that support bonded recommendations since the AP can simply use ONE BSSID to represent the MLD (and the device just scans that one). It is contemplated that this neighbor report augmentation is a good candidate for 802.11bn.

Certain embodiments described herein can utilize one or more machine learning (ML) processes, which can be used for this neighbor list recommendation, especially when grouping happens. In some embodiments, the ML-generated augmented neighbor list is generated via ML. Firstly, certain embodiments can use the AP advertised latency metric (LMA) in addition to advertised channel utilization, measured beacon RSSI as features/parameters of the device selection training. The resultant ML output can be a probability set (not a single probability per AP) which can then be used to form a ranked augmented neighbor list.

In certain embodiments, the consideration of the number of links of the MLD device (as opposed to the AP) can be formed from a similar recommendation. This can allow device links to be identified by the AP in neighbor list recommendations. It should be noted that, in certain embodiments, ML models may need to be trained with the MLD mode as a feature or parameter as follows. First, consider the type of MLD modes the device(s) support. For simultaneous or non-simultaneous transmit and receive devices all links are scan/select candidates (no limits), but for enhanced multi-link single radio modes only those links (usually 2) can be scanned and/or selected for candidates (out of 3 radios). This may limit the APs that the device actually connects to (leading to a further reduced neighbor list).

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

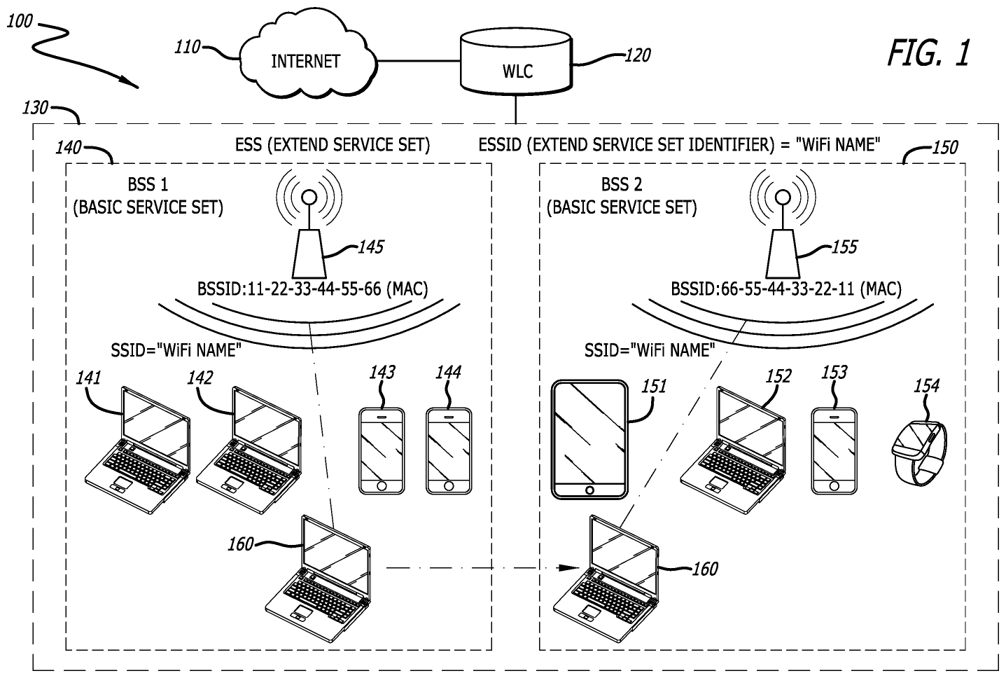

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes—comprising devices like laptops, smartphones, or other Wi-Fi-enabled devices—operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

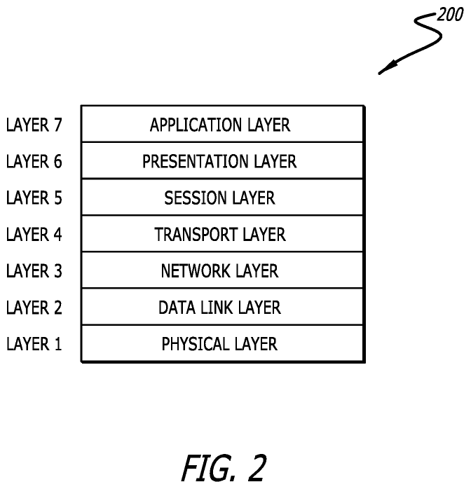

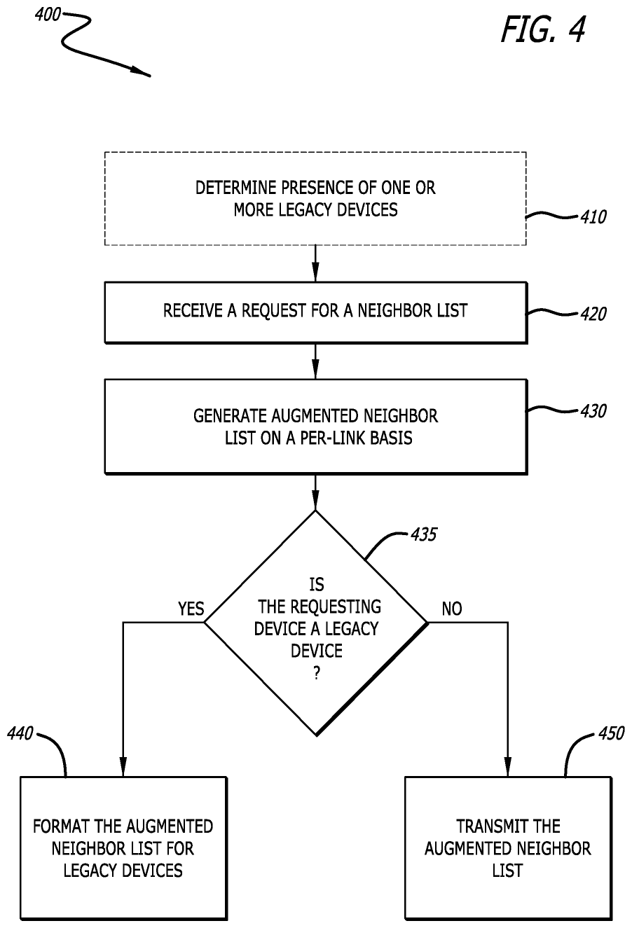

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 4, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “WiFi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-8 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer, can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer, can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-8 as required to realize a particularly desired embodiment.

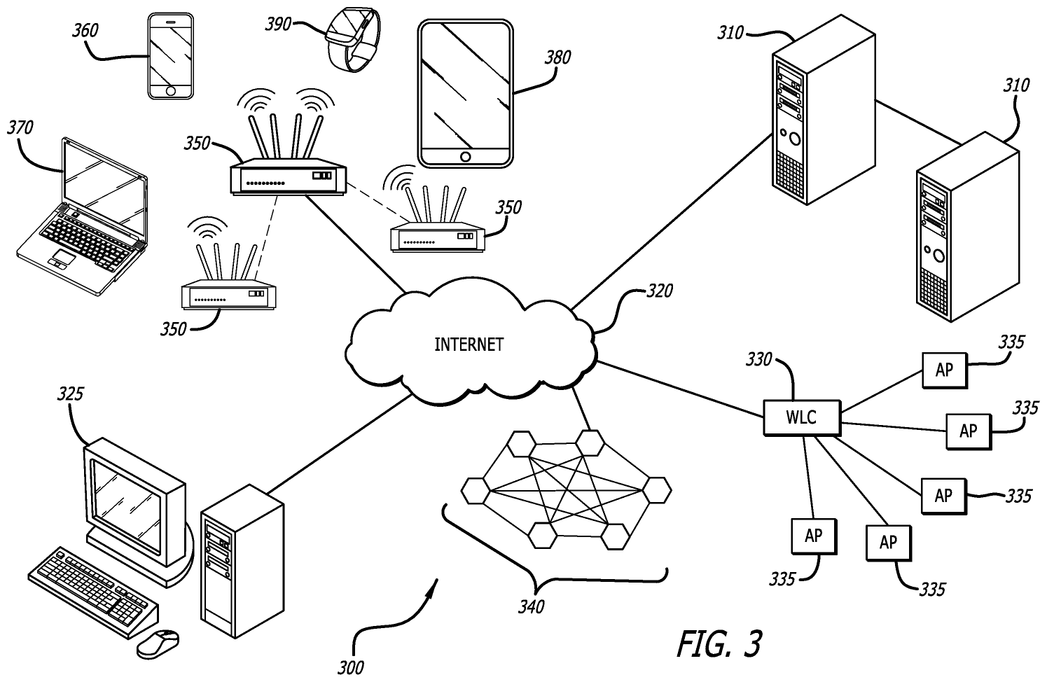

Referring to FIG. 3, a conceptual network diagram 300 of various environments that a neighbor list logic may operate on a plurality of network devices, in accordance with various embodiments of the disclosure is shown. Those skilled in the art will recognize that the neighbor list logic can include various hardware and/or software deployments and can be configured in a variety of ways. In many embodiments, the neighbor list logic can be configured as a standalone device, exist as a logic in another network device, be distributed among various network devices operating in tandem, or remotely operated as part of a cloud-based network management tool. In further embodiments, one or more servers 310 can be configured with the neighbor list logic or can otherwise operate as the neighbor list logic. In many embodiments, the neighbor list logic may operate on one or more servers 310 connected to a communication network 320 (shown as the “Internet”). The communication network 320 can include wired networks or wireless networks. The neighbor list logic can be provided as a cloud-based service that can service remote networks, such as, but not limited to a deployed network 340.

However, in additional embodiments, the neighbor list logic may be operated as a distributed logic across multiple network devices. In the embodiment depicted in FIG. 3, a plurality of network access points (APs) 350 can operate as the neighbor list logic in a distributed manner or may have one specific device operate as the neighbor list logic for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the neighbor list logic may be integrated within another network device. In the embodiment depicted in FIG. 3, a wireless LAN controller (WLC) 330 may have an integrated neighbor list logic that the WLC 330 can use to monitor or control power consumption of the APs 335 that the WLC 330 is connected to, either wired or wirelessly. In still more embodiments, a personal computer 325 may be utilized to access and/or manage various aspects of the neighbor list logic, either remotely or within the network itself. In the embodiment depicted in FIG. 3, the personal computer 325 communicates over the communication network 320 and can access the neighbor list logic of the servers 310, or the network APs 350, or the WLC 330.

Although a specific embodiment for various environments that the neighbor list logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the neighbor list logic may be provided as a device or software separate from the WLC 330 or the neighbor list logic may be integrated into the WLC 330. The elements depicted in FIG. 3 may also be interchangeable with other elements of FIGS. 1-2 and FIGS. 4-8 as required to realize a particularly desired embodiment.

Referring to FIG. 4, a flowchart depicting a process 400 for utilizing an augmented neighbor list in accordance with various embodiments of the disclosure is shown. In certain optional embodiments, the process 400 can determine the presence of one or more legacy devices (block 410). By determining the presence of a legacy device, the process 400 can adjust one or more parameters to ensure that legacy devices are not negatively affected by any subsequent process or step. This can include modifying the augmented neighbor list so the legacy devices may still process it correctly.

In many embodiments, the process 400 can receive a request for a neighbor list (block 420). The request can be done in certain embodiments via a beacon and/or response frame. The request may be received via a direct transmission, such as from a network device such as a mobile computing device, end user device, client device, etc. In certain embodiments, the request may be generated internally after the elapsing of time or some other predetermined threshold.

In a number of embodiments, the process 400 can generate an augmented neighbor list on a per-link basis (block 430). In various embodiments, the network device requesting a neighbor list can comprise a number of different transceivers capable of multiple links. As such, the generated augmented neighbor list can be formatted such that each link has an associated neighbor list, or that the augmented neighbor list is formatted to have at least one recommendation for a neighboring device per link. Because the neighbor list is formatted to add additional neighbor info for all available links, the neighbor list is said to be augmented. In some embodiments, the augmented neighbor list is generated via one or more machine learning processes.

In more embodiments, the process 400 can determine if the requesting device is a legacy device (block 435). For embodiments, where the presence of legacy devices is not known prior, the determination can be done to help direct the formatting and/or transmission of the augmented neighbor list. If it is determined that the requesting device is a legacy device, the certain embodiments of the process 400 can format the augmented neighbor list for the legacy device(s) (block 440). The format of the augmented neighbor list may, in some embodiments, be done such that, when processed by the legacy device, the neighbor list only points to one entry, which is expected in legacy devices. In more embodiments, this one entry can be selected based on various criteria, which may include what device the other links are currently connected on, what physical AP is being recommended, etc.

However, if it is determined that the requesting device is not a legacy device, then the process 400 may in various embodiments, transmit the augmented neighbor list (block 450). The transmission may be directly to the requesting network device. In certain embodiments, the process 400 can broadcast the neighbor list in such a way that the requesting network device can receive or otherwise parse the broadcasted data to determine the augmented neighbor list.

Although a specific embodiment for utilizing an augmented neighbor list suitable for carrying out the various steps, processes, methods, and operations described herein is discussed with respect to FIG. 4, any of a variety of systems and/or processes may be utilized in accordance with embodiments of the disclosure. For example, in certain deployments, there may not be any legacy devices, causing there to be no need for a determination step. The elements depicted in FIG. 4 may also be interchangeable with other elements of FIGS. 1-3 and FIGS. 5-8 as required to realize a particularly desired embodiment.

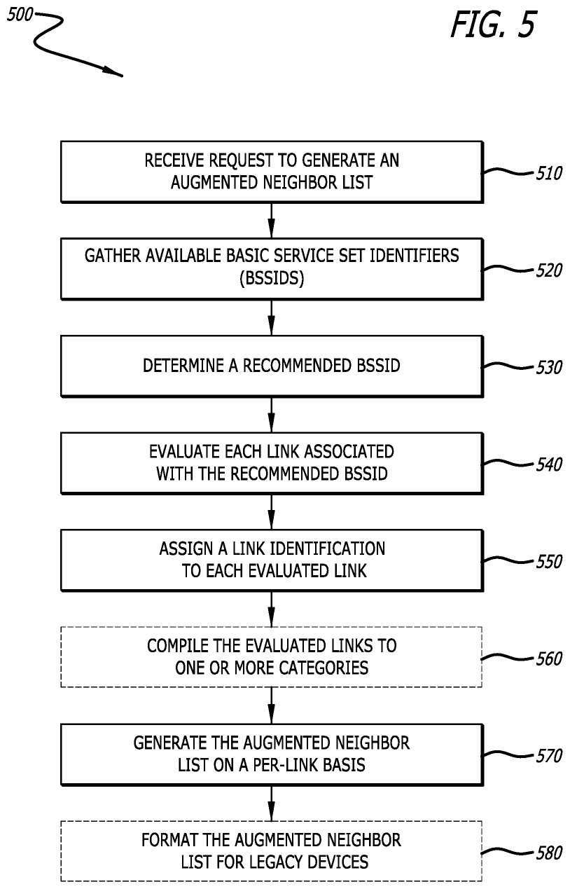

Referring to FIG. 5, a flowchart depicting a process 500 for generating an augmented neighbor list in accordance with various embodiments of the disclosure is shown. In many embodiments, the process 500 can receive a request to generate an augmented neighbor list (block 510). The request can be done in certain embodiments via a beacon and/or response frame. The request may be received via a direct transmission, such as from a network device such as a mobile computing device, end user device, client device, etc. In certain embodiments, the request may be generated internally after the elapsing of time or some other predetermined threshold.

In a number of embodiments, the process 500 can gather available basic service set identifiers (BSSIDs) (block 520). In numerous embodiments, when a network device such as an access point (AP) is tasked with creating a roaming neighbor list, it typically gathers the available Basic Service Set Identifiers (BSSIDs) through a process called passive or active scanning. Passive scanning involves the AP listening to beacon frames transmitted by nearby APs within its radio frequency range. Beacon frames are periodic broadcast messages sent by APs to announce their presence and advertise network parameters. These frames contain essential information such as the SSID (Service Set Identifier), BSSID (Basic Service Set Identifier), supported data rates, and other network capabilities. By passively scanning for beacon frames, the AP can detect nearby APs and extract their BSSIDs from the received frames.

On the other hand, active scanning involves the AP actively sending out probe request frames to solicit responses from nearby APs. When an AP receives a probe request frame, it responds with a probe response frame containing information similar to a beacon frame, including its BSSID. By sending out probe request frames on specific channels or frequencies, the network device can actively discover neighboring APs and collect their BSSIDs from the received probe responses.

In more embodiments, the process 500 can determine a recommended BSSID (block 530). In some embodiments, determining a recommended BSSID (Basic Service Set Identifier) can involve assessing various factors such as signal strength, quality, load balancing, and network policies to select the most appropriate AP or link for a client device or link. Typically, the AP with the strongest signal and highest signal-to-noise ratio (SNR) is favored to ensure optimal connectivity and performance. Load balancing algorithms can distribute client devices evenly across APs, avoiding congestion and optimizing network resources by selecting a BSSID based on the current load and utilization of each AP. Network administrators may define roaming policies that prioritize APs with specific security settings, supported data rates, or quality of service (QOS) parameters, aligning with user requirements or network policies. Moreover, client preferences and configurable settings, as well as dynamic selection algorithms that assess real-time network conditions and performance metrics, play crucial roles in determining the recommended BSSID. Additionally, the Fast BSS Transition (FT) protocol enables faster and smoother roaming experiences by pre-authenticating and caching information about neighboring APs, influencing the selection of the recommended BSSID based on FT-related parameters and optimizations. By considering these factors, network administrators can ensure improved connectivity, performance, and user experience for client devices in wireless networks.

In additional embodiments, the process 500 can evaluate each link associated with the recommended BSSID (block 540). In still more embodiments, evaluating each link associated with the recommended BSSID can involve assessing a range of parameters and performance metrics to ensure optimal connectivity and performance for client devices within a wireless network. This evaluation includes measuring the received signal strength indicator (RSSI) to gauge the signal level between the client device and the AP, with a stronger signal typically indicating better connectivity. Signal quality factors such as signal-to-noise ratio (SNR) and signal stability are also considered, as higher SNR and stable signals contribute to improved transmission quality and reliability. Additionally, the supported data rates between the client device and the AP are checked to ensure sufficient bandwidth for the intended applications and services, with higher data rates indicating faster transmission speeds and better performance. Evaluating the level of channel utilization and interference on the operating channel used by the AP is crucial, as lower channel utilization and minimal interference contribute to enhanced network performance and reliability. Furthermore, considering factors such as load balancing, roaming policies, Fast BSS Transition (FT) support, and client preferences helps ensure that each link associated with the recommended BSSID aligns with network objectives and client requirements.

In further embodiments, the process 500 can assign a link identification to each evaluated link (block 550). In certain embodiments, by assigning a link identification to each evaluated link, the process 500 can employ various methods to uniquely distinguish and manage connections. One common approach is associating each link with its respective Basic Service Set Identifier (BSSID), which uniquely identifies access points (APs) within the network. Alternatively, links can be categorized based on the Service Set Identifier (SSID) of the wireless network they belong to, providing a broader network-level distinction. Additionally, assigning link identifications based on Media Access Control (MAC) addresses allows for precise device-level identification, aiding in individual device management and troubleshooting. Moreover, links can be differentiated by operating channel and frequency, providing insight into communication characteristics, and aiding in interference mitigation strategies. Signal strength, quality metrics, and link performance parameters such as packet loss rate and latency can also inform link identifications, enabling dynamic link management and load balancing to optimize network performance and resource allocation.

In certain optional embodiments, the process 500 can compile the evaluated links to one or more categories (block 560). Groupings can be done based on the needs of the desired application. In some embodiments, the groupings can relate to different types of applications, users, bandwidth/traffic needs, etc. In more embodiments, the groupings can be generating via one or more machine-learning processes.

In still more embodiments, the process 500 can generate the augmented neighbor list on a per-link basis (block 570). As described elsewhere, the generation can be done such that each link associated with the requesting network device is provided a link for roaming. The generation can be done such that it can be transmitted back to the requested network device.

In various optional embodiments, the process 500 can format the augmented neighbor list for legacy device (block 580). The format of the augmented neighbor list may, in some embodiments, be done such that, when processed by the legacy device, the neighbor list only points to one entry, which is expected in legacy devices. In more embodiments, this one entry can be selected based on various criteria, which may include what device the other links are currently connected on, what physical AP is being recommended, etc.

Although a specific embodiment for generating an augmented neighbor list suitable for carrying out the various steps, processes, methods, and operations described herein is discussed with respect to FIG. 5, any of a variety of systems and/or processes may be utilized in accordance with embodiments of the disclosure. For example, the one or more machine learning processes can be done at a device such as an access point, but may also be done in some embodiments through a cloud-based/remote network administration system or service. The elements depicted in FIG. 5 may also be interchangeable with other elements of FIGS. 1-4 and FIGS. 6-8 as required to realize a particularly desired embodiment.

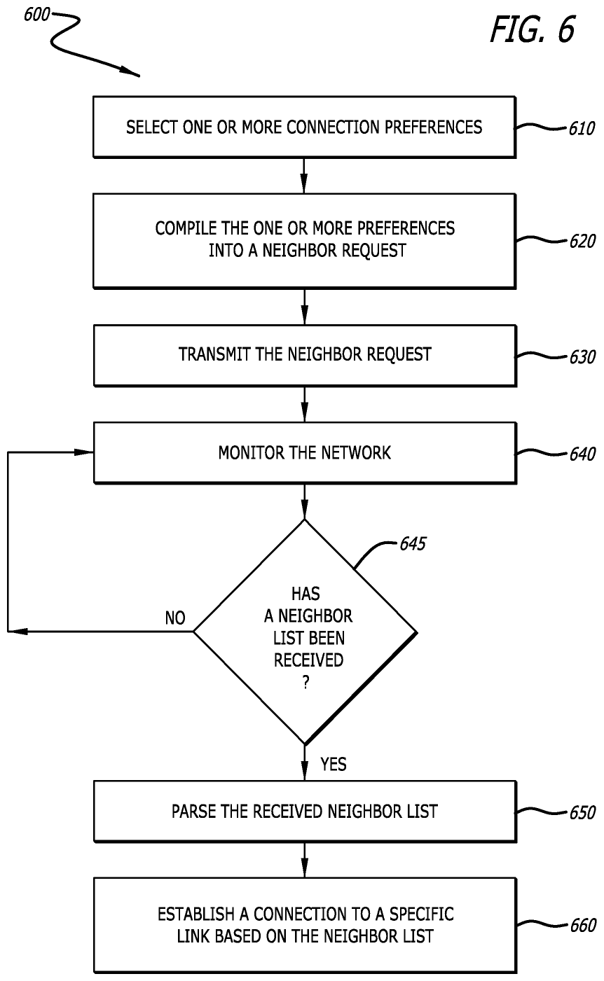

Referring to FIG. 6, a flowchart depicting a process 600 for requesting an augmented neighbor list in accordance with various embodiments of the disclosure is shown. In many embodiments, the process 600 can select one or more connection preferences (block 610). A network device, such a mobile computing device, may be configured with a plurality of different hardware setups. This can lead to one or more preferences that are desired to improve overall operational efficiency. For example, the network device may only have a single transceiver, or that others are damaged, etc. In these instances, the connection preferences can be geared toward bonding or not bonding multi-link device recommendations together.

In a number of embodiments, the process 600 can compile the one or more preferences into a neighbor request (block 620). The neighbor request can be formatted into one or more beacon and/or response frames. This can be added or implemented through an advanced Wi-Fi request system, such as, but not limited to an extended capabilities element of a header. However, the compilation can be formatted into a different transmission medium depending on the application desired.

In more embodiments, the process 600 can transmit the neighbor request (block 630). The transmission can be sent via the beacon and/or response frames. The transmission may be directly to the requesting network device. In certain embodiments, the process 600 can broadcast the neighbor request in such a way that the destination network device can receive or otherwise parse the broadcasted data to determine the neighbor list request.

In additional embodiments, the process 600 can monitor the network (block 640). This monitoring can include evaluating telemetry data and/or changes in telemetry data, such as data being uploaded, or downloaded. In some embodiments, the types of data packets, such as headers, which can indicate application usage, can be monitored for changes.

In further embodiments, the process 600 can determine if a neighbor list has been received (block 645). As described above, the neighbor list can be received through various means. If it is determined that a neighbor list has not been received, then the process 600 can continue to monitor the network (block 640). However, if it is determined that a neighbor list has been received, then the process 600 can in various embodiments, parse the received neighbor list (block 650). Parsing the neighbor list can include determining if the neighbor list is formatted on a per-link basis. This per-link basis can be done such that each link has a list of recommendations, or that each link has a single recommendation.

In still more embodiments, the process 600 can establish a connection to a specific link based on the neighbor list (block 660). As those skilled in the art will recognize, the roaming process can occur by changing a connection during operation based on a neighbor list. Specifically, in certain embodiments, one or more connections can be established to specific links based on the augmented neighbor list which can occur over a plurality of different links.

Although a specific embodiment for requesting an augmented neighbor list suitable for carrying out the various steps, processes, methods, and operations described herein is discussed with respect to FIG. 6, any of a variety of systems and/or processes may be utilized in accordance with embodiments of the disclosure. For example, some embodiments may utilize one or more machine learning processes to select a specific neighbor recommendation from a neighbor list on a per-link basis. The elements depicted in FIG. 6 may also be interchangeable with other elements of FIGS. 1-5 and FIGS. 7-8 as required to realize a particularly desired embodiment.

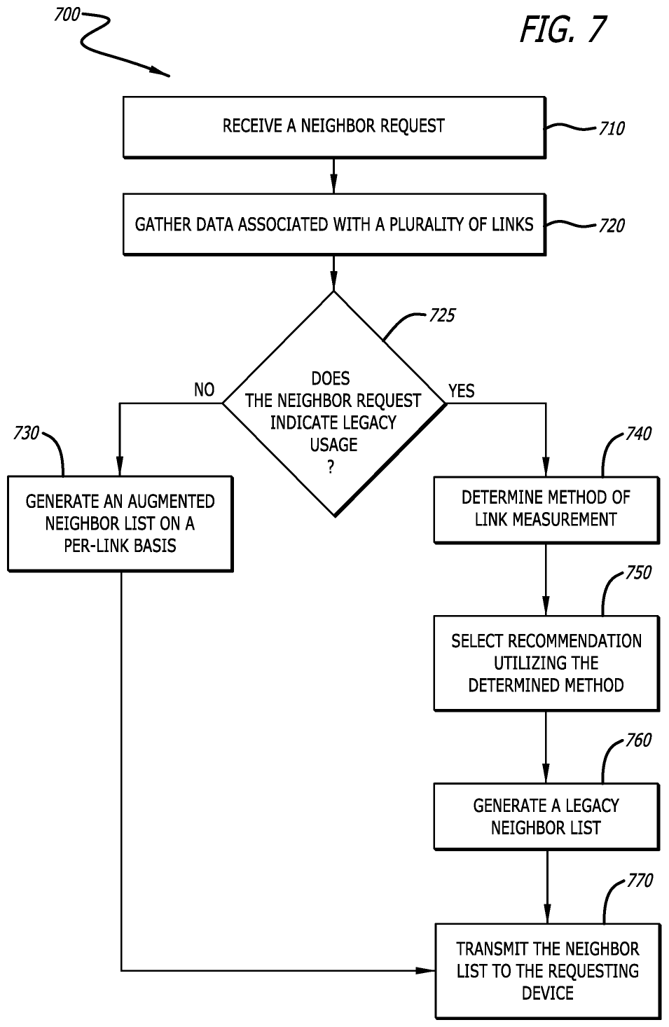

Referring to FIG. 7, a flowchart depicting a process 700 for managing a request for an augmented neighbor list in accordance with various embodiments of the disclosure is shown. In many embodiments, the process 700 can receive a neighbor request (block 710). The request can be done in certain embodiments via a beacon and/or response frame. The request may be received via a direct transmission, such as from a network device such as a mobile computing device, end user device, client device, etc. In certain embodiments, the request may be generated internally after the elapsing of time or some other predetermined threshold.

In a number of embodiments, the process 700 can gather data associated with a plurality of links (block 720). In a multi-link operation settings, where a wireless network device such as an AP manages numerous simultaneous connections with client devices, gathering data associated with each link often occurs to generate a neighbor list used for roaming. The process 700, can employ various methods to collect this data. Firstly, the process 700 may continuously monitor the wireless spectrum through passive scanning, listening for beacon frames transmitted by neighboring APs. These frames may contain crucial information such as BSSID, signal strength, and supported data rates. Additionally, in some embodiments, the process 700 may conduct active scanning by sending probe request frames to nearby client devices and APs, extracting data from the responses received. In additional embodiments, the process 700 can also monitor dynamic link metrics like signal strength, SNR, and throughput to assess link quality and prioritize roaming targets accordingly. In numerous embodiments, the process 700 can also consider load balancing and predefined roaming policies to optimize network resources and facilitate seamless roaming transitions.

In more embodiments, the process 700 can determine if the neighbor request indicates legacy usage (block 725). By determining the presence of a legacy device, the process 700 can adjust one or more parameters to ensure that legacy devices are not negatively affected by any subsequent process or step. This can include modifying the augmented neighbor list so the legacy devices may still process it correctly.

If it is determined that the neighbor request does not indicate legacy usage, then certain embodiments of the process 700 can generate an augmented neighbor list on a per-link basis (block 730). However, if it is determined that the neighbor request does indicate legacy usage, various embodiments of the process 700 can determine a method of link measurement (block 740). In a multi-link operation setup, the process 700 can utilize various methods to measure the quality and performance of individual links with client devices. For example, in certain embodiments, the process 700 can continuously monitor signal strength, which is a fundamental metric indicating the power of the wireless signal received from each client device. This measurement helps assess the proximity and strength of the connection between the device and the AP.

Additionally, the process 700 can, in some embodiments, evaluate signal-to-noise ratio (SNR), which compares the level of the desired signal (useful data) to the level of background noise and interference. A higher SNR typically indicates better link quality and improved data transmission reliability. The process may also measure throughput, which refers to the rate at which data packets are transmitted over the wireless link. Finally, embodiments, may also utilize a data/packet loss method of link measurement.

In additional embodiments, the process 700 can select a recommendation utilizing the determined method (block 750). As discussed in more detail below, one or more machine learning processes may be utilized to generate a neighbor link recommendation. The learning machine may be configured to accept one or more link measurement methods as input and subsequently output a recommendation. This process can be repeated on a per-link basis, but may, in certain embodiments, be done as a whole, meaning the output will be an entire augmented neighbor list.

In further embodiments, the process 700 can generate a legacy neighbor list (block 760). As discussed above, the augmented neighbor list may be formatted to be compatible with legacy devices as a legacy neighbor list. This can ease the transition of deployments and network management from legacy devices to more modern devices.

In still more embodiments, the process 700 can transmit the neighbor list to the requesting device (block 770). In some embodiments, this can be done in response to the generation of a neighbor list for legacy or for non-legacy usage. The transmission may be directly to the requesting network device. In certain embodiments, the process 400 can broadcast the neighbor list in such a way that the requesting network device can receive or otherwise parse the broadcasted data to determine the augmented neighbor list.

Although a specific embodiment for managing a request for an augmented neighbor list suitable for carrying out the various steps, processes, methods, and operations described herein is discussed with respect to FIG. 7, any of a variety of systems and/or processes may be utilized in accordance with embodiments of the disclosure. For example, in certain embodiments, the use of machine-learning processes can occur on the generation of both an augmented neighbor list and the legacy neighbor list. The elements depicted in FIG. 7 may also be interchangeable with other elements of FIGS. 1-6 and FIG. 8 as required to realize a particularly desired embodiment.

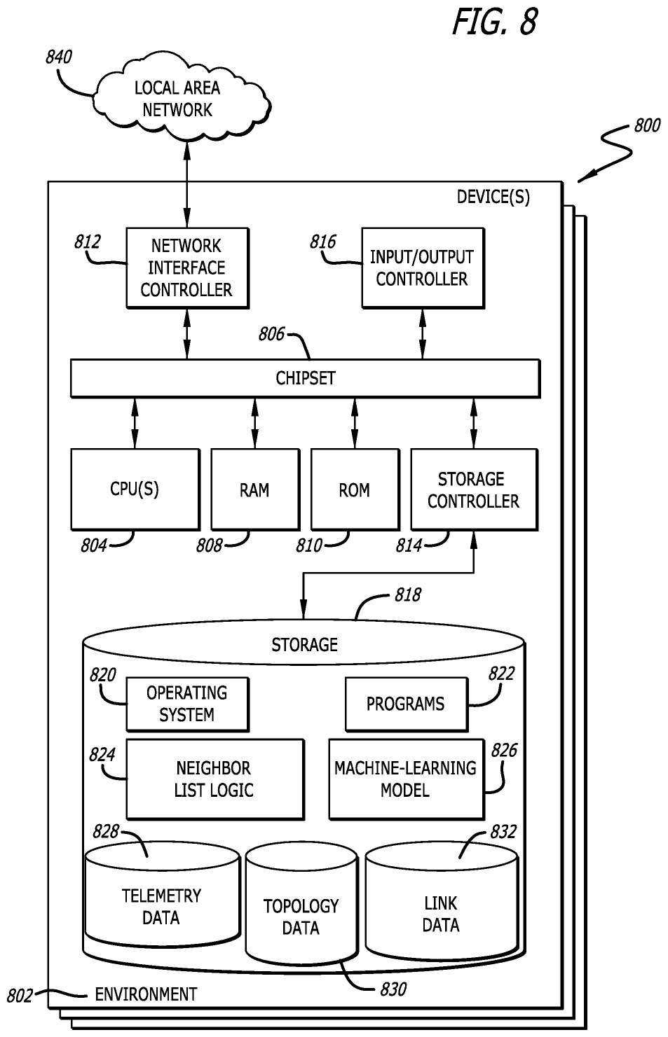

FIG. 8 is a conceptual block diagram of a device suitable for configuration with a neighbor list logic, in accordance with various embodiments of the disclosure. The embodiment of the conceptual block diagram depicted in FIG. 8 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many non-limiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In many further embodiments, the device 800 may include a neighbor list logic 824. The neighbor list logic 824 can be configured to perform one or more of the various steps, processes, operations, and/or other methods that are described above. Often, the neighbor list logic 824 can be a set of instructions stored within a non-volatile memory that, when executed by the controller(s)/processor(s) 804 can carry out these steps, etc. In some embodiments, the neighbor list logic 824 may be a client application that resides on a network-connected device, such as, but not limited to, a server, switch, personal or mobile computing device in a single or distributed arrangement.

In some embodiments, telemetry data 828 can encompass real-time measurements crucial for monitoring and optimizing network performance. It may include details like bandwidth usage, latency, packet loss, and error rates, providing insights into data transmission quality and identifying potential issues. Telemetry data 828 may also cover traffic patterns and application performance, supporting capacity planning and ensuring optimal user experience. The collection and analysis of this data are essential for proactive network management, facilitated by advanced monitoring tools and technologies.

In various embodiments, topology data 830 can comprise information detailing the physical or logical arrangement of network devices and their interconnections. This data can provide insights into the structure of the network, including the relationships between routers, switches, servers, and other components. Topology data 830 can describe the actual layout of devices, such as their placement in a building or across multiple locations, while logical topology data may focus on the communication paths and relationships between devices regardless of their physical location. Understanding network topology is crucial for troubleshooting, optimizing performance, suggesting relevant neighbors for roaming, and planning for scalability. It can enable network administrators to identify potential points of failure, ensure efficient data flow, and make informed decisions about network expansion or reconfiguration. Advanced tools and technologies are often employed to visualize and analyze topology data 830, aiding in the effective management and maintenance of complex network infrastructures.

In a number of embodiments, link data 832 refers to the information exchanged between devices or access points involved in establishing and maintaining a connection. In multi-link operations, such as those employed in seamless roaming scenarios, the exchange of link data 832 becomes desired for ensuring a smooth transition between different access points or networks without interruption of service. Link data typically comprises various pieces of information related to the state of the connection, network characteristics, and device capabilities. This data is exchanged between the client device (such as a smartphone, laptop, or IoT device) and the access points (APs) or base stations responsible for providing network connectivity. Examples of link data 832 include signal strength, quality of the connection, available bandwidth, supported encryption protocols, and other network parameters.

During the roaming process, when a device moves from one access point's coverage area to another, it needs to establish a connection with the new access point seamlessly to maintain continuous network access. This transition relies on the exchange of link data 832 between the device and the access points involved. The device scans for available access points, evaluates their signal strength and quality, and selects the most suitable one based on the received link data 832. The link data 832 exchanged during roaming assists in determining the optimal access point to connect to, taking into account factors such as signal strength, load balancing across access points, and network congestion. For instance, if the device detects that the signal strength from the current access point is weakening as it moves away, it will initiate a search for alternative access points with stronger signals. The link data 832 exchanged helps the device make informed decisions about when to hand off the connection to a new access point, ensuring minimal disruption to the user experience.

Moreover, link data 832 may also include authentication and security information necessary for establishing a secure connection with the new access point. This could involve exchanging authentication credentials or encryption keys to ensure the confidentiality and integrity of data transmitted over the network. By sharing this security-related link data 832, the device can seamlessly authenticate and establish a secure connection with the new access point, maintaining privacy and preventing unauthorized access.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826.

The ML model(s) 826 can be configured to generate inferences to make predictions or draw conclusions from data. An inference can be considered the output of a process of applying a model to new data. This can occur by learning from at least the telemetry data 828, the power topology data 830, and the station data 832. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Machine learning processes such as ML model(s) 826 can play a role in optimizing the selection of an optimal neighbor for a client device on a per-link basis during roaming in a multi-link operation wireless network. In some embodiments, extraction, and selection of relevant features from the data collected occurs from each link in a multi-link operation setup. Other features such as signal strength, signal-to-noise ratio (SNR), throughput, and packet loss rate can also be extracted to provide insight into the quality and performance of each potential neighbor. Machine learning processes can assist in identifying the most informative features that contribute to determining link quality and predicting optimal roaming decisions.

Following feature extraction, one or more ML model(s) 826 can be trained using historical data containing labeled examples of link quality metrics and corresponding roaming outcomes. During the training phase, the models can “learn” the underlying patterns and relationships between input features and the optimal selection of neighbors for roaming. Various classification or regression algorithms can be employed for this purpose, with the objective of accurately predicting the quality and performance of potential neighboring access points based on real-time measurements.

In various embodiments, in response to the ML model(s) 826 being trained and validated, they can be deployed in the field. These embodiments can utilize the collected data and learned patterns to generate predictions or scores indicating the suitability of each neighbor for roaming on a per-link basis. These predictions consider factors such as signal strength, SNR, throughput, and packet loss rate, as well as any predefined roaming policies or criteria. Often, the neighbor with the highest predicted quality or performance metrics is recommended for the client device to roam to, facilitating seamless handover and improved connectivity.

Continuous monitoring and feedback mechanisms can be additional components of the ML model(s) 826. As new data becomes available and roaming outcomes are observed, the ML model(s) 826 can be retrained and adapted to evolving network conditions. This iterative process may ensure that the ML model(s) 826 remain accurate and effective in selecting optimal neighbors for roaming on a per-link basis, thereby enhancing the roaming experience for client devices with improved connectivity, performance, and reliability.

Although a specific embodiment for a device suitable for configuration with the neighbor list logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or APs. The elements depicted in FIG. 8 may also be interchangeable with other elements of FIGS. 1-7 as required to realize a particularly desired embodiment.

Additionally, although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one wireless transceiver configured to provide access to a network; and
a memory communicatively coupled to the processor, wherein the memory comprises a neighbor list logic that is configured to:
receive a request for a neighbor list from a network device;
determine a presence of two or more links associated with the network device; and
generate an augmented neighbor list based on the two or more links.

2. The device of claim 1, wherein the augmented neighbor list comprises a plurality of recommended links.

3. The device of claim 2, wherein the plurality of recommended links are configured on a per-link basis.

4. The device of claim 3, wherein the neighbor list logic is further configured to gather an available basic service set identifier (BSSID) prior to generating the augmented neighbor list.

5. The device of claim 4, wherein the neighbor list logic is further configured to determine a recommended BSSID prior to generating the augmented neighbor list.

6. The device of claim 5, wherein the augmented neighbor list is configured with at least the recommended BSSID.

7. The device of claim 6, wherein the neighbor list logic is further configured to evaluate each link associated with the recommend BSSID.

8. The device of claim 7, wherein each evaluated link is assigned a link identification.

9. The device of claim 8, wherein each link is compiled into one or more categories.

10. The device of claim 2, wherein the augmented neighbor list is formatted for compatibility with legacy network devices.

11. The device of claim 10, wherein the compatibility is achieved through grouping of at least one basic service set identifier (BSSID).

12. The device of claim 11, wherein the grouping of the at least one BSSID configures the augmented neighbor list to point to a single entry.

13. The device of claim 1, wherein the request for a neighbor list comprises at least a bonding preference for receiving recommendations for pairing with multi-link devices.

14. The device of claim 13, wherein generating the augmented neighbor list is based on at least the bonding preference.

15. The device of claim 1, wherein generating the augmented neighbor list comprises at least evaluating at least one performance metric associated with the network device.

16. The device of claim 15, wherein the evaluation comprises utilizing at least one machine-learning process configured to utilize the at least one performance metric as an input.

17. The device of claim 16, wherein the at least one performance metric can include: received signal strength indicators, time to last mile performance, or quality of service adherence.

18. A device, comprising:
a processor;
at least one network interface configured to provide access to a network; and
a memory communicatively coupled to the processor, wherein the memory comprises a neighbor list logic that is configured to:
receive a request for a neighbor list from a network device;
determine a presence of two or more links associated with the network device; and
evaluate a plurality of available links within neighboring access points;
generate a link recommendation for each of the two or more links based on the plurality of available links;
generate an augmented neighbor list based on the generated link recommendations.

19. The device of claim 14, wherein the neighbor list logic is further configured to transmit the augmented neighbor list to the network device.

20. A method of managing multi-link wireless network connections, comprising:
receiving a request for a neighbor list from a network device;
parsing the received request;
determining a presence of two or more links associated with the network device; and
generating an augmented neighbor list on a per-link basis for each of the two or more links.
